(19) United States
(12) Patent Application Publication
(10) Pub. No.: US 2004/0041848 A1
(43) Pub. Date: Mar. 4, 2004

(54) Marking machine user interface enhancement via portable electronic device

(75) Inventors: Donald L. Wegeng, Fairport, NY (US); Bruce E. Talbert, Webster, NY (US)

Correspondence Address: Patent Documentation Center, Xerox Corporation, Xerox Square 20th Floor, 100 Clinton Ave. S., Rochester, NY, 14644, US

(73) Assignee: Xerox Corporation

(21) Appl. No.: 10/272,870

(22) Filed: Oct. 16, 2002

Related U.S. Application Data
(60) Provisional application No. 60/407,231, filed on Aug. 29, 2002.

(51) Int. Cl. G09G 5/00

(52) U.S. Cl. 345/864; 345/169

(57) ABSTRACT

A user interface extension allows data entry into a field of a marking machine user interface from an electronic device via compatible communications ports. In embodiments, a marking machine includes a UI into which data must be entered. The user takes the UI to the point at which data must be entered, then lets the machine know that data will be transmitted from another source, at which point the machine begins monitoring its communications ports for the data. The user enters or selects data to be transmitted from the electronic device, then indicates that the data is ready to be sent, at which point the electronic device transmits the data to the machine via a communications port of the electronic device. Examples of suitable marking machines include multifunction inkjet and xerographic machines. Examples of suitable electronic devices include laptop computers, PDAs, cellular telephones, and PDA/telephone hybrid devices.

### CROSS REFERENCE TO RELATED APPLICATIONS

This application is based on a Provisional Patent Application No. 60/407,231, filed Aug. 29, 2002.

### FIELD OF THE INVENTION

Embodiments relate to marking machine user interfaces (UIs). More particularly, embodiments relate to allowing interaction and supplementation of a marking machine user interface through portable electronic devices, such as personal digital assistants (PDAs), cellular/wireless telephones, hybrid PDA/telephones, and portable computers, among other devices.

### BACKGROUND AND SUMMARY

The local UIs on most marking machines, such as multifunction devices and electrophotographic and xerographic printers and copiers, are tradeoffs between functionality and size/cost. One outcome of this tradeoff is that the local UI design makes it easy for the user to enter numeric data, but more difficult to enter text data. Hard buttons are typically used for entering numeric data only, with alternate entry interfaces being used for text data. Typically, devices display a keyboard on a touch screen that allows users to select each letter to be entered. However, the touch area for each letter is small, making it easy to select the wrong letter. Thus, existing methods for entering text can be cumbersome to use.

This situation was not a problem when users did not need to enter much text information. However, as new functionality has been added to marking machines, the need for users to enter text data has increased. For example, the “scan to email” feature allows users to enter one or more email addresses as the destination for a scanning job. Using a touch screen as described above to enter an email address (such as “donald.wegeng@usa.xerox.com”) is cumbersome. Since it is not practical to replace the local UI hardware on these products with something that is more text-friendly, an alternative means for entering text data would be useful.

The use of electronic devices, such as portable computers, hand-held Personal Digital Assistants (PDAs), cellular/wireless telephones, and PDA/phone hybrids, has become commonplace in many office environments. Laptop computers allow data entry in a number of ways, including keyboard, speech-to-text, and stylus-based entry. PDAs and hybrids usually provide a stylus-based mechanism for entering data, though small keyboards are also employed on some models. As an example, Palm OS based devices support text data input using a stylus-based pen stroke interface. Users of these devices quickly become proficient at entering text. Thus, electronic devices provide many ways to enter data that are much easier to use than those provided in typical marking machine UIs. Additionally, many electronic devices can store databases of contact information in the form of address books and the like. It would be advantageous for a user to select a contact entry and have the device automatically send contact information to the marking machine.

Further, most electronic device include at least one communications port that can be used to transfer data to a marking machine connected to a compatible communications port. Such communications ports can be wireless, such as Infrared Data Association (IrDA) compatible interfaces or BlueTooth interfaces, which can provide a wireless method for transferring data between the electronic device and the marking machine.

Embodiments provide for the use of electronic devices, such as, for example, laptop computers, hand-held Personal Digital Assistants (PDA), cellular/wireless telephones, and PDA/telephone hybrids, as alternative interfaces for entering data, such as text data, into the local user interface of a device, such as a marking machine. The portable electronic device effectively acts as an extension of the interface of the marking machine. Embodiments employ communications ports, such as infrared ports and other wireless communications ports, of electronic devices for transmitting data from the electronic device to the marking machine. Data, such as text, can be entered into the electronic device using its normal method, such as with a stylus. Software on the electronic device accepts the data and transmits it to the marking machine via the communications port of the electronic device. A compatible communications port connected to the marking machine receives the data, and software on the marking machine inserts the data into an active entry field on the local UI.

The user uses the marking machine UI to select appropriate job options and brings up a data entry field. At this point, the UI presents an element, such as a graphically-rendered button, that instructs the marking machine to read the data from the connected communications port when activated. When this selection is made, the marking device monitors data coming in via the communications port and the user starts an application on the electronic device. Once the application is going, the user can select appropriate data from their address book or enter the appropriate data using the text entry mechanism on the electronic device. The application also provides a way for the user to indicate data entry completion, at which point the application transmits the data via the electronic device's communications port. The data is read by the marking machine and inserted into the recipient field on the local UI.

In embodiments, the application simply reads and transmits the data; it is not aware of the context in which the data was being used. This allows the application to be generic in nature, since all knowledge about the specific application is contained in the software running on the marking machine 10.

### BRIEF DESCRIPTION OF THE DRAWINGS

FIG. 1 is a schematic representation of a marking machine with which embodiments could be employed.

FIG. 2 is a schematic representation of a prior art user interface (UI) of a marking machine, such as that of FIG. 1.

FIG. 3 is a schematic representation of a laptop/portable computer according to embodiments.

FIG. 4 is a schematic representation of a personal digital assistant (PDA) according to embodiments.

FIG. 5 is a schematic representation of a personal digital assistant (PDA) according to additional embodiments.

FIG. 6 is a schematic representation of a cellular/wireless telephone according to embodiments.

FIG. 7 is a schematic representation of a UI of a marking machine according to embodiments.

FIG. 8 is a schematic representation of a communications port connected to a marking machine according to embodiments.

### DETAILED DESCRIPTION

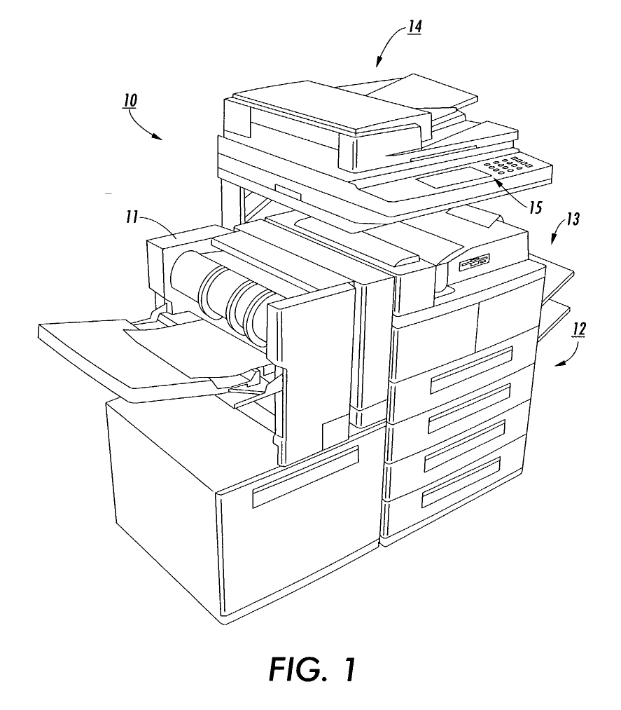

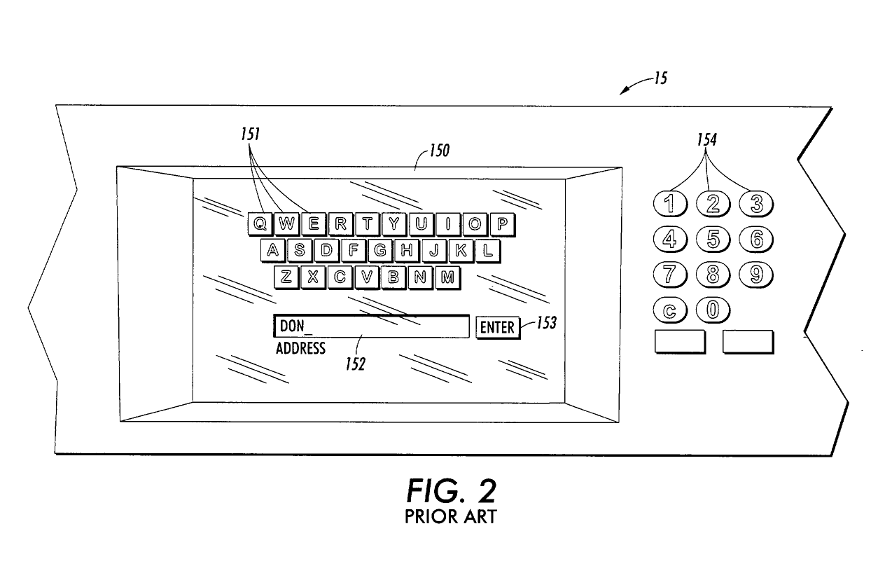

Embodiments will be described with reference to the accompanying FIGS. 1-8. As shown in FIG. 1, a marking machine 10 can include a media supply 11, a marking section 12, and an output section 13, as well as an input section 14 and a user interface section 15. The media a supply 11 can include paper, transparency media, or any other media as appropriate for use by the marking section 12. The marking section 12 can be liquid ink jet based, phase change ink jet based, electrophotographic, xerographic, or based on other technologies as appropriate. The output section 13 can include a simple output tray, multiple bins, and/or media handlers and finishers as appropriate. The input section 14 can include a platen, a scanner, or any combination thereof as appropriate.

The UI section 15 will typically include a touch screen display 150, such as an LCD panel on which a graphically-represented keyboard including GUI elements 151, such as buttons, for the characters that can be entered. Additionally, data entry fields 152 will be presented on the display 150 in certain circumstances, and a submission element 153 will be included to indicate that the user is done entering data in the fields 152. Physical buttons 154 are typically provided for entry of numerical data and elemental control of the marking machine 10.

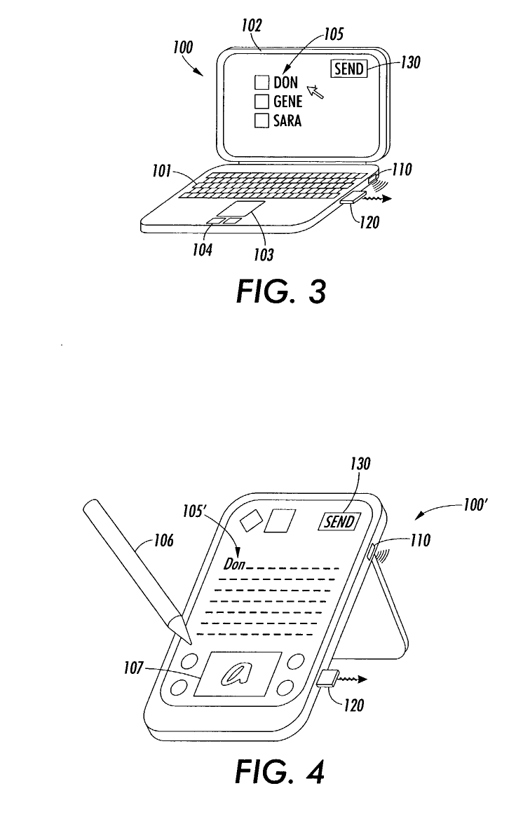

As seen in FIGS. 3-6, electronic devices 100, 100′, 100″, 100′″ can comprise a portable computer 100, varieties of PDAs 100′, 100″, and cellular/wireless telephones 100′″. A portable computer 100, such as that shown schematically in FIG. 3, can include a keyboard 101, a display 102, a pointer control device 103, and a “mouse” button 104. The portable computer can include an address book or other database from which data 105 can be withdrawn, or the data 105 can be entered on demand with the keyboard. Such portable computers also include at least one communications port, such as IrDA port 110 and BlueTooth port 120.

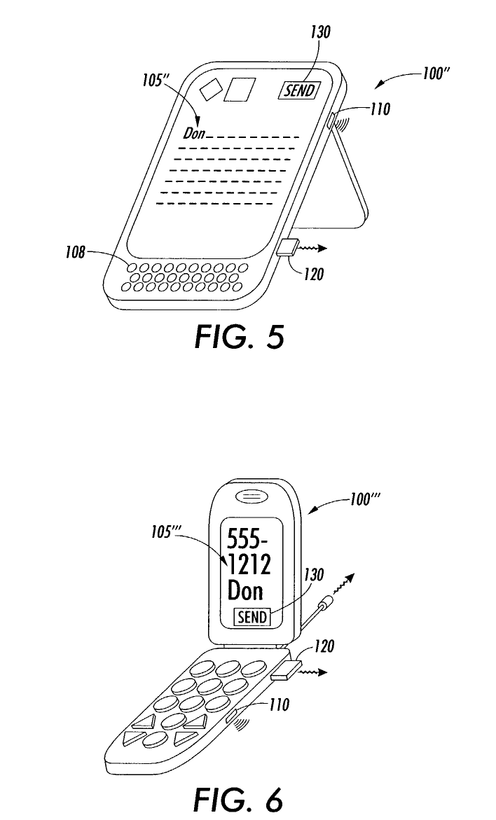

As seen particularly in FIG. 4, a PDA 100′ can include a stylus 106 that can be used in conjunction with a specialized area 107 of its touch screen 102′ for entry of data 105. The specialized area 107 is monitored for handwritten strokes that software on the PDA can translate into characters on the screen. Other PDAs, such as an alternative PDA 100″ schematically illustrated in FIG. 5, can include a small keyboard 108 for data entry. Such alternative PDAs can still include a touch screen 102′ and employ a stylus 106 for other functions, but will typically substitute the keyboard for a specialized area 107 for handwritten character recognition. In either case, PDAs 100′, 100″ can include address books or the like from which the data 105′ can be withdrawn, or the data 105′ can be entered on demand with the stylus 106 or keyboard 108.

The electronic device can also take the form of a cellular/wireless telephone 100′″. Such a telephone 100′″ can include a display 102″, such as an LCD or OLED, a keypad 101′, and an antenna 109. Telephones 100′″ often include implementation of the Short Message Service (SMS) protocol to send short messages from one telephone to another. An excellent tutorial in SMS can be found at the International Engineering Consortium web site and is hereby incorporated by reference. The particular URL is <http://www.iec.org/online/tutorials/wire_sms/>. The SMS protocol can be used in embodiments to allow data 105″ to be sent from a telephone 100′″ to the marking machine with the inclusion of SMS protocol in the marking machine. Additionally, a cellular/wireless telephone 100′″ often includes a communications port to which an accessory device can be attached, which can include an infrared port 110 or a radio frequency port 120 through which data 105″ can be transmitted. Other communications protocols can also be used, wireless and otherwise, with embodiments.

It is foreseeable that telephones and other electronic devices that do not currently will come with such ports built in and/or with expansion ports to which such communications ports can be attached, especially in light of the trend of late for telephones and PDAs to be merged into hybrid electronic devices. It is also foreseeable that other radio frequency, infrared, and visible light communications protocols will arise to which embodiments could be adapted and which thus fall within the scope of the invention.

The electronic device 100, 100′, 100″, 100′″ is used as an extension to marking machine 10 local UI 15 by sending data 105, 105′, 105″ from the electronic device to an entry field 152 of the UI 15. A user who needs to enter data, such as an email address, into the marking machine UI could enter the data into the electronic device and transmit (“beam”) the data to the marking machine 10. The marking machine 10 can then insert the text into the appropriate field on the local UI.

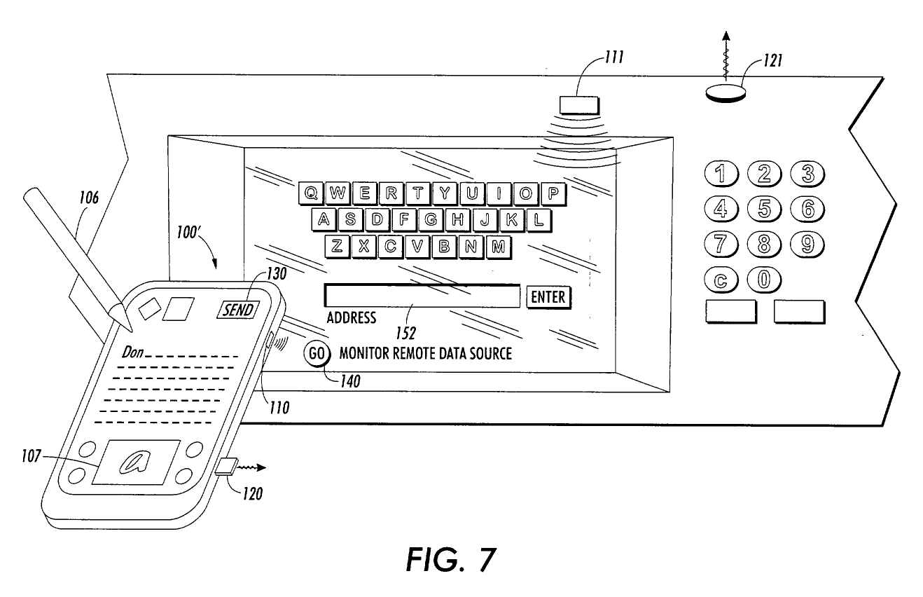

Thus, with reference particularly to FIG. 7, embodiments comprise initiating an action on a marking machine 10 via its UI 15, reaching a point at which data entry into a data entry field 152 must take place, and notifying the marking machine 10 that the data will come from a source other than the UI 15 proper with, for example, a GUI element 140, such as a “Go” button. Activating the GUI element 140 starts an application on the marking machine 10 that monitors communications ports 111, 121 for the data 105, 105′, 105″ to be entered.

The user continues by entering data 105, 105′, 105″ on the electronic device, such as one of the devices 100, 100′, 100″, 100′″ illustrated in FIGS. 3-6. Once the data is ready, the user indicates that the data entry is complete/ready, as with a GUI element 130 on the electronic device. An example of a transaction according to embodiments is the use of a PDA (the electronic device) to transmit a fax number (the data) to the GUI of a multifunction device (the marking machine), though many other scenarios fall within the scope of the invention, as will be apparent to one of skill in the art.

The data can be entered using a stylus 106, a specialized handwriting recognition section 107 of the electronic device display 102′, by a keyboard 101, 101′, 108, by speech-to-text software, or by any other suitable methods or combination of entry methods. Alternatively, embodiments allow the user to continue by selecting an entry from a contact database, address book, or the like as the data 105, 105′, 105″. The selection can be accomplished using a stylus 106, keyboard 101, 101′, 108, pointing device, or any other suitable input device.

Once the GUI element 130 on the electronic device has been triggered, an application on the electronic device transmits the data 105, 105′, 105″ to the marking machine 10 via a communications port, such as an infrared communications port 110 or a radio frequency communications port 120. The application on the marking machine 10 detects the transmission and inserts the data into data entry field 152. The user can then confirm the entry of the data in the data entry field 152 and submit the data to the marking machine with, for example, a GUI element 153, such as an “ENTER” virtual button.

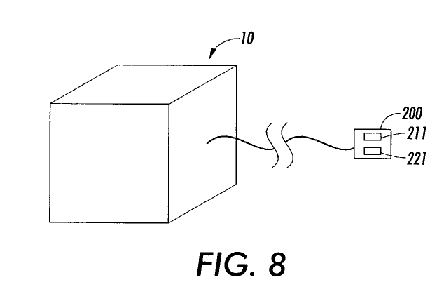

In additional embodiments, the communications port 111, 121 of the marking machine 10 is part of the marking machine, but the communications port 111, 121 can also be directly connected to the marking machine 10. Further, an alternative, as shown in FIG. 8, is to use a network module 200 to which the communications port 111, 121 is connected. The network module 200 can then be plugged into a network 20 to which the marking machine 10 is connected. Such a network module 200 could then be used by more than one marking machine 10 on the network 20.

The preceding description of the invention is exemplary in nature as it pertains to particular embodiments disclosed and no limitation as to the scope of the claims is intended by the particular choices of embodiments disclosed. Currently unforeseeable modifications of the present invention may occur to those skilled in the art in the future, and these modifications, including equivalents thereof, are intended to be included within the scope of the present invention.

1. An interface comprising:
an input device with which a user can enter data into an electronic device;
a transmission system allowing transmission of data to a local user interface of a marking machine.

2. An interface according to claim 1 wherein the transmission system uses a wireless networking communications port of the electronic device.

3. The interface of claim 2 wherein the wireless networking system includes an infrared port.

4. The interface of claim 3 wherein the infrared port is an Infrared Data Association (IrDA) compatible infrared port.

5. The interface of claim 2 wherein the wireless networking system includes a radio based communications port.

6. The interface of claim 5 wherein the radio based communications port is a BlueTooth port.

7. The interface of claim 5 wherein the radio based communications port is an IEEE 802.11 based port.

8. The interface of claim 2 wherein the electronic device is a cellular telephone including Short Message Service and the marking machine can receive Short Message Service messages including the data a user enters.

9. The interface of claim 1 wherein the input device comprises a stylus.

10. The interface of claim 1 implemented as an applet in the electronic device.

11. The interface of claim 10 further comprising a component resident on the marking machine that receives the data and inserts the data into an active field of the local UI of the marking machine.

12. The interface of claim 11 wherein the local UI of the marking machine includes a numeric keypad and a touch screen.

13. A method of effectively extending a marking machine local UI comprising:
providing an electronic device with a communications port and an input device;
entering data on the electronic device with the input device; and
transmitting the data to the marking machine via the communications port.

14. The method of claim 13 further comprising providing a software application on the marking machine that inserts the transmitted data into an active area on the local UI of the marking machine.

15. The method of claim 14 further comprising equipping the marking machine with a wireless communications port.

16. The method of claim 15 wherein the communications ports on the computer and the marking machine are IrDA compatible.

17. The method of claim 15 wherein equipping includes connecting the wireless communications port to the marking machine.

18. The method of claim 15 wherein equipping includes installing the wireless communications on a network to which the marking machine is connected.

19. The method of claim 13 wherein providing an electronic device with a communications port and an input device includes providing a stylus interface.

20. The method of claim 13 wherein the marking machine includes a UI dialog into which an entry must be made, and a command to receive data into the UI dialog from the communications port of the computer.

21. The method of claim 13 wherein entering text data includes indicating when text data entry is complete.

22. The method of claim 13 wherein entering text data includes reading at least a portion of an entry in a database on the computer.

23. The method of claim 22 wherein the database is an address book and reading at least a portion of an entry in a database includes reading an e-mail address from the address book.

24. The method of claim 22 wherein the database is an address book and reading at least a portion of an entry in a database includes reading a fax number from the address book.

25. An interface comprising:
an input device with which a user can enter data into an electronic device;
a transmission system allowing transmission of data to a local user interface of a marking machine via a wireless networking communications port of the electronic device;
the interface further comprising:
interacting with a UI of the marking machine to enable an active area for data entry;
indicating to the marking machine UI that data will be entered via a remote device;
monitoring by the marking machine of a communications port of the marking machine;
providing an electronic device with a communications port and an input device;
entering data on the electronic device with the input device;
transmitting the data to the marking machine via the communications port;
detecting, by the marking machine, incoming data from the electronic device; and
entering the incoming data into the active UI area.
